(19) United States
(12) Patent Application Publication
(10) Pub. No.: US 2018/0276334 A1
(43) Pub. Date: Sep. 27, 2018

(54) Gene test platform method

(71) Applicant: Gene Target Technology CO. LTD., Kaohsiung City (TW)

(72) Inventors: YI-FANG CHEN, Kaohsiung City (TW); SUZ-KAI HSIUNG, Kaohsiung City (TW); YI-JUN LIN, Kaohsiung City (TW)

(21) Appl. No.: 15/827,545

(22) Filed: Nov. 30, 2017

(30) Foreign Application Priority Data
Mar. 21, 2017 (TW) 106109397

(51) Int. Cl. G06F 19/18; G06F 19/22; G06F 17/30; G06F 19/20

(52) U.S. Cl. CPC G06F 19/18; G06F 19/20; G06F 17/30002; G06F 19/22

(57) ABSTRACT

A gene test platform method gives a recommendation based on a test result to a subject and comprises steps of a subject's test result in a gene test being input to a supporting advice module; the supporting advice module producing a therapeutic formula combination which is correlated with significant genetic data as per the test result and transmitted to a gene test user interface; the gene test user interface displaying the recommended therapeutic formula combination to a subject and further comprising a feedback interface through which a subject raises any question or sends any feedback immediately.

### BACKGROUND OF THE INVENTION

### 1. Field of the Invention

The present disclosure relates to a gene test platform method, particularly a gene test platform method through which a recommendation based on a test result is given to a subject.

### 2. Description of the Prior Art

Genes influence human and disease development considerably such that the phenomena on human beings induced by gene expressions are issues studied intensively by the medical field right now. In this regard, the genetic group related to adult health or aging and the corresponding civil diseases common in the human society are shown as follows:

Antioxidant gene: GPX1 (glutathione peroxidase) exists in blood, liver, mitochondria and cytosol mostly. When excessive peroxides are produced in tissues or cells, the enzyme activity will decrease due to cofactors unreduced immediately. Therefore, reactive oxygen and free radicals are removed by antioxidant enzymes as well as non-enzymatic antioxidant substances in cooperative interactions through which the organism is free from oxidative damages attributed to reactive oxygen species for least cell injury or aging.

Anti-aging gene: MMP3, which is characteristic of regulating degradation of extracellular matrices, for example, collagen, glycoprotein, fibroblast, elastin and so on, is to protect protein molecules and keep skin elasticity. For skin elasticity, degradation and generation of extracellular matrices in normal skin should be kept in balance. However, the gene expressions stimulated by UV or a person's increasing age have effects on skin collagens which are important structural proteins to maintain elasticity of connective tissues. As a result, skin will loosen, wrinkle and age with collagens damaged.

Moisturizing gene: HAS2 is one of three hyaluronate synthases (HAS1, HAS2, HAS3) in vertebrates for generation of hyaluronic acid which is one of main ingredients of epidemic cellular matrices and a disaccharide straight-chain polymer consisting of glucuronic acid (UDP) and UDP-N-acetylglucosamine and serving as a natural moisturizer in the human body.

Moreover, the genetic group related to a child's learning/development as well as corresponding common symptoms is shown as follows:

Comprehension (corresponding gene: CHRM2): CHRM2 encodes muscarinic neurotransmitter receptors. With the function to transmit bioactivity of important cholinergic substances in the central nervous system, muscarinic acetylcholine receptors which regulate lots of signaling pathways for nervous excitation, synapsis remodeling and negative feedback of acetylcholine are activated by muscarine but restrained by atropine. CHRM2 associated with attention, learning, memory and recognition strengthens the brain's thinking path, relating to innovation, communication, question analysis, induction, deduction, expression, learning and absorption; a person's comprehension is influenced by attention, popular expression, application example, interest, knowledge background and brain development which becomes more mature so does comprehension.

Learning capacity (corresponding gene: OPRM1): OPRM1 encodes μ-opioid receptors on a cell, which are classified as G protein-coupled receptors and combined with β-endorphin and send chemical signals to be received by the brain. According to research findings, an object with “A” (or “a”) alleles performs well in learning capacity which is attributed to OPRM1 associated with regulating learning, memory and spontaneous activity.

Language competence (corresponding gene: FOXP2): Expressed on the brain and used to regulate the corticostriatal system, FOXP2 on the seventh chromosome has effect on a person's oral speech expression and language learning/development. FOXP2 for encoding of transcription factors involves in organogenesis and histogenesis, for example, neurogenesis, and makes a difference to an object's facial and oral muscles responsible for articulation while the gene expression changes.

In general, a subject for a gene test who is short of professional knowledge has no idea to respond to his/her gene expressions which are critical to adult health or child development. Thus, it is a key issue to provide a subject with a professional advice or reply to tested gene expressions.

### SUMMARY OF THE INVENTION

The present disclosure relates to a gene test platform method by which a professional recommendation for a nutrient, drug or educational material combination as the reference of body health or talent development is provided to a subject after a gene test.

As mentioned previously, the genetic group related to an adult is associated with a variety of genes, for example, GPX1 for anti-oxidation, MMP3 for anti-aging, HAS2 for skin moisturizing, etc.

On the other hand, the genetic group related to a child's talent performance is also associated with a variety of genes, for example, CHRM2 for intelligent comprehension, OPRM for learning capacity, FOXP for language competence, etc.

| | | |
|---|---|---|
| 1 | Anti-oxidation | GPX1 |
| 2 | Anti-aging | MMP3 |
| 3 | Moisturizing | HAS2 |

According to the above table, a subject's gene expressions, which are derived from test results received by a supporting advice module and checked in a corresponding gene comparison module, are also presented in GPX1, MMP3 and HAS2 in the following table: (1) a recommendation to supplement Vitamin C or coenzyme Q10 is given by the supporting advice module because of the relationship between GPX1 and anti-oxidation as shown in the above table; (2) a recommendation to supplement fullerene is given by the supporting advice module in virtue of the relationship between MMP3 and anti-aging; (3) a recommendation to supplement hyaluronic acid is given by the supporting advice module due to the relationship between HAS2 and moisturizing. As such, a health advice as shown in a corresponding formula is provided to a subject after a gene test from which the relationship between a gene expression and health status has been derived.

The significant genetic data correlated with a child's talent and his/her gene expressions studied herein are presented in an embodiment as shown in the following table in which a child's one gene expression in the field “Gene” is related to his/her one capacity in the field “Item related to Gene”.

| | | |
|---|---|---|
| 1 | Comprehension | CHRM2 |
| 2 | Learning capacity | OPRM1 |
| 3 | Language competence | FOXP2 |

When gene expressions of a child subject derived from the child's test results received by the supporting advice module and checked by the corresponding gene comparison module are associated with CHRM2, OPRM1 and FOXP2, some courses can be provided to the child. For example, an “innovation expression” course (a “child yoga” course; a “language training”) to promote a child's comprehension (learning capacity; language competence) which is correlated with GPX1 (OPRM1; FOXP2) as shown in the above table is recommended by the supporting advice module. As such, a gene test platform method is able to give a recommendation to a subject after a gene test according to the relationship between an adult (a child) subject's gene expression and his/her health (talent) status.

Because the general public or subjects know little about connotative meaning of the above gene test, a gene test platform method in the present disclosure is intended to assist the general public or subjects to familiarize themselves with knowledge for a gene test, individual physical/mental status, and subsequent maintenance, training or promotion.

To this end, a gene test platform method provided in the present disclosure comprises steps as follows: a test result for one subject in the gene test is input to a supporting advice module which comprises a corresponding gene comparison module with an adult genome comparison module and a child genome comparison module wherein the corresponding gene comparison module relies on the test result to decide the adult genome comparison module or the child genome comparison module is available for production of a therapeutic formula combination based on information in a database.

The corresponding gene comparison module compares the test result and significant genetic data saved in the database.

For an adult subject, the corresponding gene comparison module depends on the test result and significant genetic data checked by the adult genome comparison module to give a nutrient combination or a drug combination as a recommendation for a subject's body health which is prescribed for a civil disease, metabolic disease or early-stage cancer corresponding to the known adult gene group in each case.

For a child subject, the corresponding gene comparison module depends on the test result and significant genetic data checked by the child genome comparison module to give a nutrient combination or an educational material combination as a reference for a subject's future development in each case.

The nutrient combination, the drug combination or the educational material combination belongs to the therapeutic formula combination.

The adult genome comparison module (the child genome comparison module) is able to compare a test result with the corresponding significant genetic data.

The supporting advice module transmits the therapeutic formula combination to a gene test user interface installed on a mobile device, a tablet computer or a PC; the gene test user interface is an interface through which the nutrient combination, the drug combination or the educational material combination in the therapeutic formula combination is provided to and understood by a subject such that the subject reads and comprehends a drug, nutrient or educational material provided by the supporting advice module for health restoration or development based on a specific gene after a gene test.

The therapeutic formula combination and the significant genetic data are stored in a database through which the therapeutic formula combination is reviewed by a subject again and the significant genetic data is accessed by the corresponding gene comparison module repeatedly.

Moreover, the gene test user interface comprises a feedback interface through which a subject raises any question or sends any feedback immediately and a platform service agent replies to the subject for correct medication, nutrients or educational materials forthwith.

### BRIEF DESCRIPTION OF THE DRAWINGS

The technical content, purposes and effects of a gene test platform method in the present disclosure are further explained in the preferred embodiment and accompanying drawings which are shown as follows:

FIG. 1 is a flow chart for steps of a gene test platform method.

FIG. 2 is a schematic view for a gene test user interface of a gene test platform method in an embodiment.

FIG. 3 is a schematic view for a feedback interface in the gene test user interface of a gene test platform method in an embodiment.

FIG. 4 is a system flow chart for a gene test platform method.

### DETAILED DESCRIPTION OF THE PREFERRED EMBODIMENT

The purposes, characteristics and advantages of a gene test platform method in the present disclosure are clearly explained in the preferred embodiment and accompanying drawings as follows. It is notable that a gene test platform method is described but not limited to the preferred embodiment herein.

In the present disclosure, a recommendation as a therapeutic formula combination correlated with significant genetic data, which is correlative data associated with gene expressions and an available therapy (or educational materials) and saved in a genome database, is given by a corresponding gene comparison module of a supporting advice module wherein a method to collect specimens for creation of the significant genetic data is explained as follows:

First of all, a prepared biochip (membrane array) is placed in a reaction box in which preheated hybridization reagents are added; then, complementary DNAs (cDNA) which were labeled in pre-hybridization completely are added into the reaction box for hybridization kept at 42° C. for at least 16 hours; the biochip removed from the reaction box for vibration cleaning in wash buffers reacts with blocking buffers and are cleaned by wash buffers again; Anti-DIG-AP buffers are added for a reaction and then removed; detection buffers are added for a reaction and then removed; color development reagents (NBT-BCIP) for a color reaction are added until the total reaction is completed.

Colors on the membrane array which was dried completely are scanned with the Epson Perfection 1670 flatbed scanner (SEIKO EPSON Corp, Nagano-ken, Japan; resolution: 3000 dpi×3000 dpi) and results are saved in an image file; the spot intensity ratio for gene expressions on the biochip presented in the image file are analyzed by AlphaEase®FC (Alpha Innotech Corp, San Leandro, Calif.): the image file is read by AlphaEase®FC with which the spot density at one target gene and the β-actin are analyzed; the data is output for calculations of the mean, the standard deviation and the ratio (i.e., gene expression=gene expression value/β-actin value) of two duplicate genes.

The details of the above steps are explained as follows:

Preparation of probes: RNAs in stimulated cells are extracted and reverse transcribed into cDNAs; cDNAs (20 μl) are placed in a 0.6 ml test tube for denaturation at 95° C. in 5 minutes after which the test tube is placed on ice immediately for reduction of temperature; DIG (digoxigenin)-Highprime (Cat. No. 1-585-606; 3 μl) is added into the test tube which is kept in an incubator for labeling specimens at 37° C. in more than 4 hours.

Preparation of a membrane array: Four genes, internal control and the nucleotide sequence of β-actin are selected by OMP3 (Oligonucleotide Modeling Platform3, DNA Software, Inc., Ann Arbor, Mich.); the size of a membrane is cut with tweezers and scissors as required; oligonucleotides, which was processed at 100° C. in 2 minutes and then immediately cooled on ice, is dispensed on the membrane with an automated dispenser (AD3050TM Dispensing Systems (BioDot Inc, Irvine, Calif.)): each droplet with 1 μl oligonucleotides dispensed on the membrane for one target gene is kept away from the other one by 1.5 mm; the membrane is dried and irradiated by an ultraviolet crosslinker (XL-1000 UV) at 200 Joules for a crosslink reaction; the membrane on which oligonucleotides for one target gene is fixed is placed inside a dryer for analyses of the gene.

Hybridization: Hybridization buffers (1.5 ml) preheated in 42° C. are added into the prepared membrane array (wrapped by aluminum foils for no evaporation of hybridization buffers in a reaction box and kept in vibration); the membrane array are removed to an oven for pre-hybridization (revolution: 100 rpm; temperature: 42° C.; time: 2 hours) during which cDNAs are bound easily; cDNAs labeled completely are heated at 95° C. for 5 minutes and then cooled on ice for 30 seconds before spin-down; cDNAs (22 μL) are uniformly added into the reaction box in which a membrane array is held (note: no bubble produced; no membrane hit by tips) and the reaction box wrapped by aluminum foils (or preservative films) for no evaporation of hybridization buffers is kept in hybridization (revolution: 100 rpm; temperature: 42° C.; time: at least 16 hours).

Post-hybridization: The membrane array after hybridization is removed and placed in fresh Wash-I buffers (DIG Wash and Block Buffer Set) for vibration cleaning (revolution: 100 rpm; temperature: 42° C.; time: 10 minutes) (note: repeat the step twice); Wash-I buffers are dumped and replaced by fresh Wash-II buffers; Wash-II buffers are added for vibration cleaning (revolution: 100 rpm; room temperature; time: 20 minutes) and then dumped (note: repeat the step twice); Wash-II buffers are added again for vibration cleaning (revolution: 100 rpm; room temperature; time: 5 minutes); blocking buffers are added for vibration (revolution: 100 rpm; room temperature; time: 90 minutes) and then dumped; Wash-III buffers are added for vibration cleaning (revolution: 100 rpm; time: 20 minutes) and then dumped (note: repeat the step twice); Anti-DIG-AP buffers are added for vibration (revolution: 100 rpm; room temperature; time: 90 minutes) and then dumped and Wash-III buffers are added for vibration cleaning (revolution: 100 rpm; room temperature; time: 15 minutes) and then dumped (note: repeat the step twice); detection buffers are added for vibration (revolution: 100 rpm; room temperature; time: 20 minutes) and then dumped; a color development reagent (NBT-BCIP) mixture newly prepared is added for a chromogenic reaction in 15 minutes; secondary water, which is added for terminating the reaction immediately when color is developed, is added for vibration (revolution: 100 rpm) and then dumped after 5 minutes (note: repeat the step five times until the chromogenic reaction is stopped); the membrane array on which excessive water is wiped with a piece of absorbent paper is dried for scanning developed colors by the Epson Perfection 1670 flatbed scanner (SEIKO EPSON Corp, Nagano-ken, Japan) (resolution: 3000 dpi×3000 dpi) and saving an image file.

Analysis of the spot intensity ratio for a membrane array: The spot intensity ratio in an image file is analyzed with AlphaEase®FC (Alpha Innotech Corp, San Leandro, Calif.) for analyses of gene expressions. The image file is read by AlphaEase®FC with which the spot density of one target gene and β-actin is analyzed; data is output for calculations of the mean, the standard deviation and the ratio (i.e., gene expression=gene expression value/β-actin value) of two duplicate genes.

The method of creating a genome database based on collected specimens for comparisons of genes is taken as an embodiment in which how to screen and test correlative data, that is, significant genetic data, for a corresponding gene comparison module is described.

Moreover, the gene test for subjects is based on steps as follows:

(1) Specimens of subjects are provided to a test group;
(2) DNAs are extracted from subjects' specimens; and
(3) Test results are identified via instrument operation.

In Step 3, a specific prior operation for the distinct instrument operation, for example, real-time PCR (real-time Polymerase Chain Reaction), is shown as follows: the probe and reagents for DNAs and a target gene are mixed in a reaction tube for instrument operation from which test results are determined after two hours directly. Alternatively, a prior operation for the DNA sequencer is shown as follows: a polymerase chain reaction for primers of DNAs and a target gene is induced first such that a target segment is enlarged; the target segment is cut and placed in the DNA sequencer for a sequencing test and test results are determined in Chromas Lite.

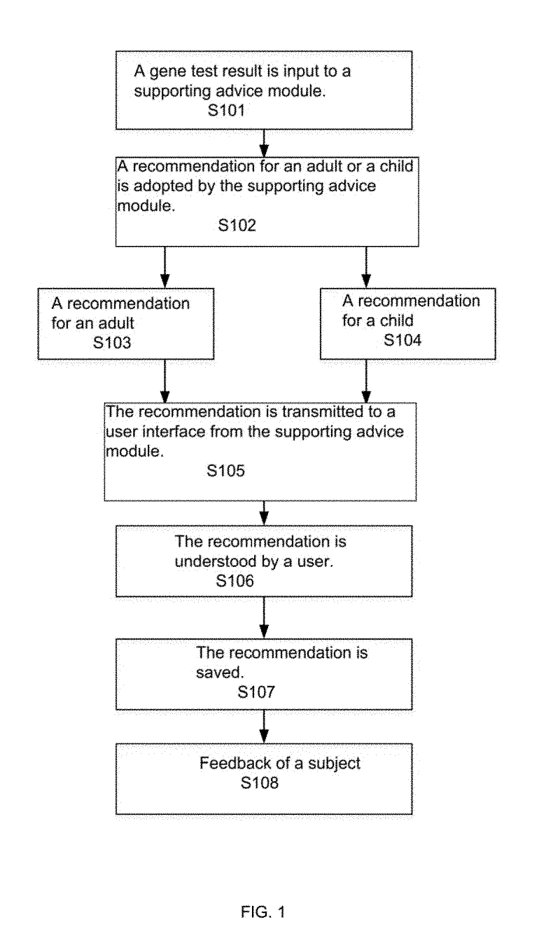

As shown in FIG. 1, the schematic view for steps of a gene test platform method, the detailed steps in the present disclosure are shown as follows:

Step S101, a gene test result input to a supporting advice module: a test result for one subject in the gene test is input to a supporting advice module.

Step S102, a recommendation for an adult or a child adopted by the supporting advice module: the supporting advice module comprises a corresponding gene comparison module which has an adult genome comparison module as well as a child genome comparison module and relies on a test result to decide that the adult genome comparison module or the child genome comparison module is available, that is, Step S103 or Step S104 is selected, according to significant genetic data in a database.

Step S103, a recommendation for an adult: the corresponding gene comparison module refers to the adult genome comparison module and produces a nutrient combination or a drug combination corresponding to significant gene data identified in a test result.

Step S104, a recommendation for a child: the corresponding gene comparison module refers to the child genome comparison module and produces a nutrient combination or an educational material combination corresponding to significant gene data identified in a test result.

Step S105, a recommendation transmitted to a user interface from the supporting advice module: the supporting advice module transmits a therapeutic formula combination (that is, a nutrient combination as well as a drug combination or a specific nutrient combination as well as an educational material combination) to a gene test user interface.

Step S106, a recommendation understood by a subject: a subject comprehends the nutrient combination as well as the drug combination or the specific nutrient combination as well as the educational material combination shown on the user interface.

Step S107, saving a recommendation: a subject uses the gene test user interface to save the therapeutic formula combination in a database for reviews later.

Step S108, feedback of a subject: the gene test user interface comprises a feedback interface through which a subject raises any question or gives feedbacks and a service agent replies to the subject.

Having depended on the above test to check gene expressions, the patent applicant found several gene expressions, which are in favor of correlative data of nutrient content or educational material and regarded as significant genetic data available in the corresponding gene comparison module of the supporting advice module for gene comparisons. As shown in the table below, a gene test platform method provides a subject with best therapy or talent development for a tested gene by nutrient content associated with a subject.

The significant genetic data correlated with a child's talent and his/her gene expression studied herein is presented in an embodiment as shown in the following table in which a child's one gene expression in the field “Gene” is related to his/her one capacity in the field “Item related to Gene”.

| | Item related to Gene | Gene |
|---|---|---|
| 1 | Comprehension | CHRM2 |
| 2 | Learning capacity | OPRM1 |
| 3 | Language competence | FOXP2 |

As shown in the table above, tests results for comprehension, learning capacity and language competence of a child in an embodiment are explained as follows:

Comprehension (corresponding gene: CHRM2): CHRM2 encodes muscarinic neurotransmitter receptors. With the function to transmit bioactivity of important cholinergic substances in the central nervous system, muscarinic acetylcholine receptors which regulate lots of signaling pathways for nervous excitation, synapsis remodeling and negative feedback of acetylcholine are activated by muscarine but restrained by atropine. CHRM2 associated with attention, learning, memory and recognition strengthens the brain's thinking path, relating to innovation, communication, question analysis, induction, deduction, expression, learning and absorption; a person's comprehension is influenced by attention, popular expression, application example, interest, knowledge background and brain development which becomes more mature so does comprehension. The comprehension of a child whose genetic predispotion is good in comprehension is stimulated by acquired brain development, postnatal attention cultivating, thinking training, knowledge accumulation and enlightenment of interests. As an inhibitory factor to weaken biological activity of receptor proteins, CHRM2, the TT genotype, is in favor of the brain's thinking path for good analysis, abstract reasoning and potential to comprehend knowledge; one child's comprehension, which is an important factor associated with a child's learning and different from the other child's, is reflected in his/her responses through which individualized teaching in a quicker pace (slower pace) is given to a child with better (worse) comprehension.

Therefore, the educational material combination herein is presented as an “innovation expression” course which refers to visualization association based on interesting images for arising a child's interests in memory, strengthening development and training of organizing capacity and expressing innovation and discloses two main principles in design, “listening is more important than speaking” and “take time to speak after observation”. In this regard, a series of story map boards designed as auxiliary tools of education and comprising various items such as figure, background, location and time are illustrated by a teacher and operated by a child practically for narration of a story continuously. Moreover, Lego bricks are taken as assistant stage properties for narration of a story by a child and clear understanding of a story line by his/her companions.

Learning capacity (corresponding gene: OPRM1): OPRM1 encodes μ-opioid receptors on a cell, which are classified as G protein-coupled receptors and combined with β-endorphin and send chemical signals received by the brain. According to research findings, an object with “A” (or “a”) alleles performs well in learning capacity which is attributed to OPRM1 associated with regulating learning, memory and spontaneous activity.

In the present disclosure, the educational material combination is presented as a “child yoga” course which allows children to learn how to concentrate their attentions on something or relax their minds, stabilize children's dispositions, promote sensory integration and multiply learning efficiency by integrating children's bodies and souls. With scenarios based on games and dramatic elements created in the course, children poised at imperfect yoga asana play various roles through which children who let their bodies conduct minds are brought into their deep hearts and distinguish their endless wonderful energy from hearts.

For example, the yoga course for children is divided into five stages: (A) Game: a hungry snake (cobra pose) posed by a child watches food and raises its head; (B) Drama: the little riding hood, who is walking to visit her sick granny but discovered by the big bad wolf, enjoy colorful flowers (flower pose), lush trees (tree pose), naughty rabbits (rabbit pose) and adorable cats (cat pose) in the forest and is finally eaten by the big bad wolf which disguises as the granny at home (baby sleep pose); (C) Music & dance: children do yoga exercise to the rhythm of music; (D) Savasana: children under a teacher's direction meditate five to ten minutes to relax muscles, regulate breathes and calm minds; (E) Massage: a teacher instructs children how to use hands or massage brushes to massage their bodies, feel sense of safety in hearts and enjoy tactile sensation.

Language competence (corresponding gene: FOXP2): Expressed on the brain and used to regulate the corticostriatal system, FOXP2 on the seventh chromosome has effect on a person's oral speech expression and language learning and development. FOXP2 for encoding of transcription factors involves in organogenesis and histogenesis, for example, neurogenesis, and makes a difference to an object's facial and oral muscles responsible for articulation while the gene expression changes. The language competence of a person taking the above courses, which should be reviewed for any effect on an individual case as references of syllabus adjustment, is promoted simultaneously.

Educational material

| | Innovation expression | |
|---|---|---|
| Gene | course | Child yoga |
| CHRM2 | ✓ | |
| OPRM1 | | ✓ |
| FOXP2 | ✓ | ✓ |

The significant genetic data for relationships between an adult's health and gene expression in the present disclosure is shown in the table below as an embodiment, that is, an adult's one health issue in the field “Item related to Gene” is associated with one gene expression in the field “Gene” which was screened.

| | Item related to Gene | Gene |
|---|---|---|
| 1 | Anti-oxidation | GPX1 |
| 2 | Anti-aging | MMP3 |
| 3 | Moisturizing | HAS2 |

According to the above table, a subject's gene expressions in an embodiment, which are derived from test results received by the supporting advice module and checked in the corresponding gene comparison module, are also presented in GPX1, MMP3 and HAS2 in the following table: (1) a recommendation to supplement Vitamin C or coenzyme Q10 is given by the supporting advice module because of the relationship between GPX1 and anti-oxidation as shown in the above table; (2) a recommendation to supplement fullerene is given by the supporting advice module in virtue of the relationship between MMP3 and anti-aging; (3) a recommendation to supplement hyaluronic acid is given by the supporting advice module due to the relationship between HAS2 and moisturizing. As such, a health advice as shown in a corresponding formula is provided to a subject who completed a gene test from which the relationships between gene expressions and health status were derived.

Formula

| | Vitmin C/ | | Hyaluronic |
|---|---|---|---|
| Gene | coenzyme Q10 | Fullerene | acid |
| GPX1 | ✓ | | |
| MMP3 | | ✓ | |
| HAS2 | | | ✓ |

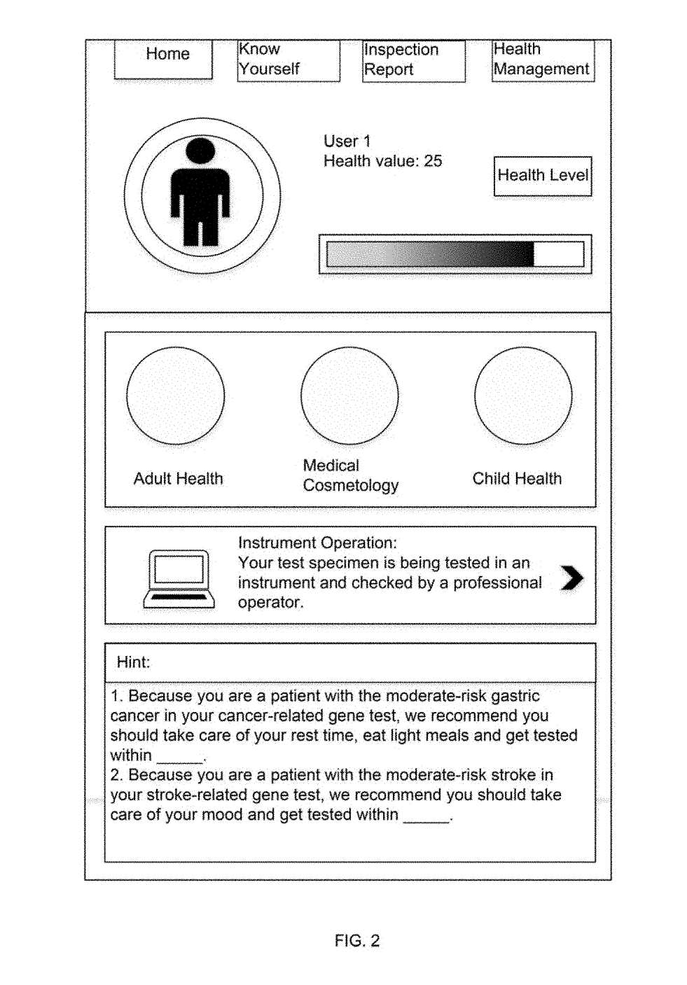

Referring to FIG. 2, which is a schematic view for a gene test user interface of a gene test platform method in an embodiment. As shown in FIG. 2, the gene test user interface comprises various menu bars/buttons through which different pages are switchable: the homepage in FIG. 2 presents objects such as user's photo, username (User 1) and loading bar for the login count accumulated; the icons for “adult health”, “medical cosmetology” and “child health” to be clicked by a user are displayed at the center of the interface which also presents the rate of progress of a gene test (for example, instrument operation in FIG. 2); the field at the bottom of the interface present hints of a user's health status.

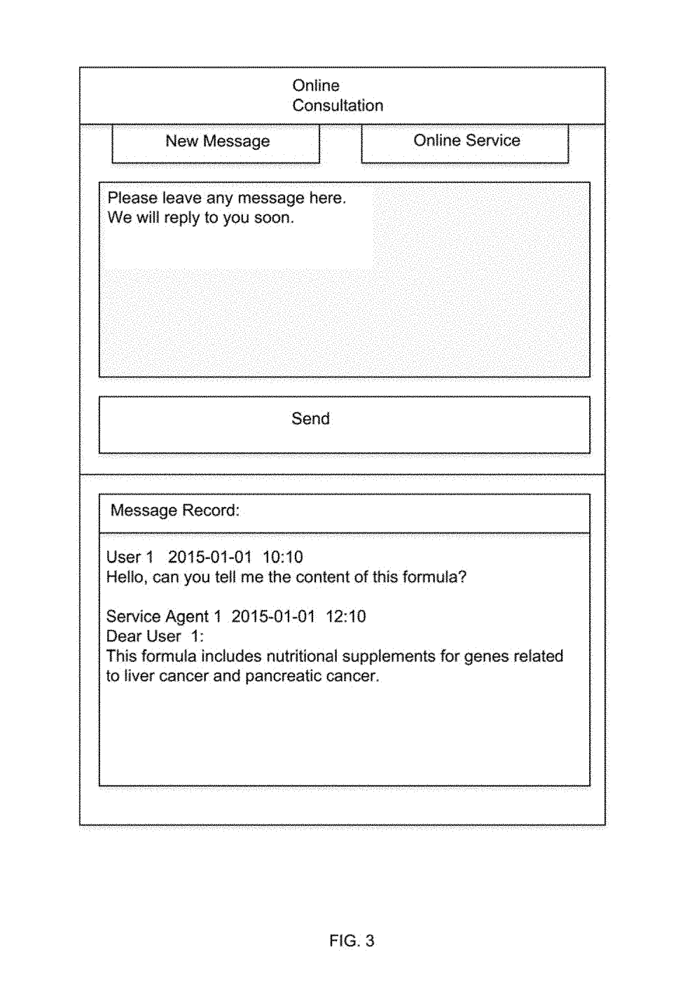

Referring to FIG. 3, which is a schematic view for a feedback interface in the gene test user interface of the gene test platform method. The feedback interface presents a page name at the top, that is, “online consultation” with two switchable menu buttons, “new message” and “online service”, and an interactive dialog box at the upper half in which a message to be sent is entered; the feedback interface displays logs for past records at the lower half.

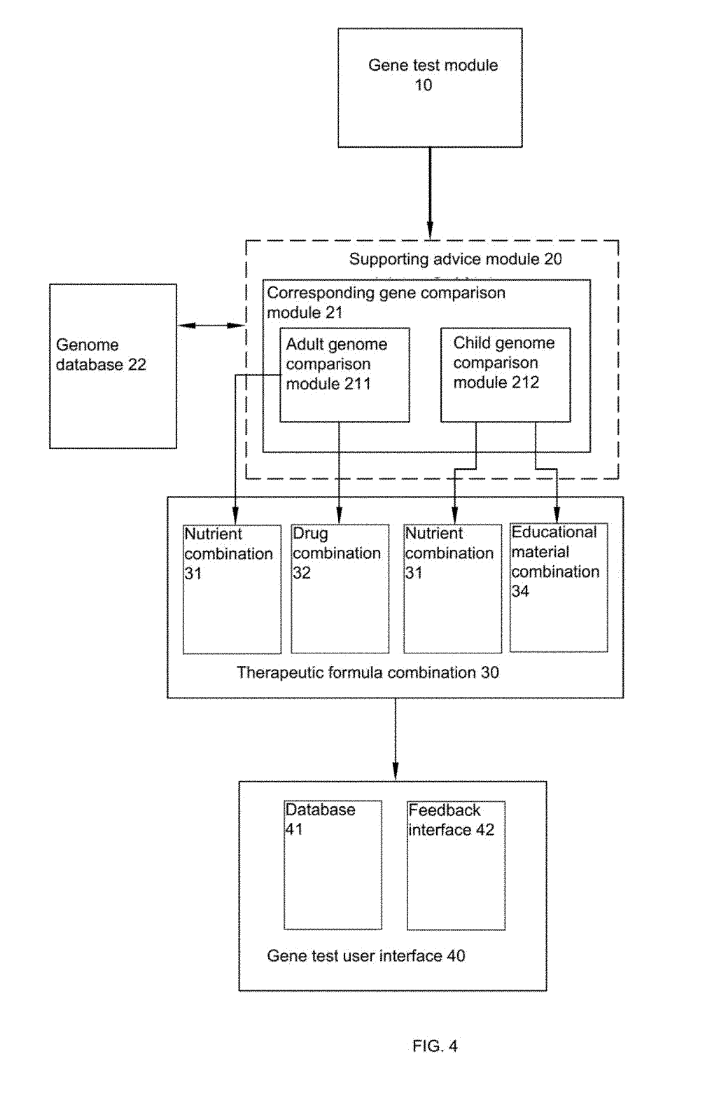

Referring to FIG. 4, which illustrates a gene test system in another embodiment. The gene test system comprises a gene test module 10 from which a subject's test result is derived and a supporting advice module 20 which checks the test result through the corresponding gene comparison module 21. The corresponding gene comparison module 21, which further comprises an adult genome comparison module 211 and a child genome comparison module 212, relies on the test result input into a genome database 22 to decide a therapeutic formula combination 30 created by the adult genome comparison module 211 or the child genome comparison module 212.

For an adult subject, the corresponding gene comparison module (21) refers to significant genetic data checked by the adult genome comparison module (211) based on a test result to give a nutrient combination (31) or a drug combination (32) corresponding to the significant genetic data; for a child subject, the corresponding gene comparison module (21) refers to significant genetic data checked by the child genome comparison module (212) based on a test result to give a nutrient combination (33) or an educational material combination (34) corresponding to the significant genetic data. As such, a recommendation is provided to a subject according to his/her health status in an individual case.

The supporting advice module (20) transmits the therapeutic formula combination (30) to a gene test user interface (40) installed on a mobile device, a tablet computer or a PC and comprising a database (41) and a feedback interface (42): the database (41) is used to store recommended information correlated with the nutrient combinations (31), (33), the drug combination (32) and the educational material combination (34) in the therapeutic formula combination (30); the feedback interface (42) is an interface through which a subject sends any feedback immediately and a platform service agent replies to the subject for correct medication, nutrients or educational materials forthwith.

The above descriptions and accompanying drawings explain the preferred embodiment in the present disclosure; however, the embodiment is not intended to limit the scope of the patent application. Any equivalent modification or change without departing from the spirit of the patent specification should be incorporated in the claims thereinafter.

In summary, a gene test platform method, which is innovative work in technical ideas and features several effects in contrast to conventional methods, meets novelty and non-obviousness for patentability.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A gene test platform method, comprising steps as follows:
a supporting advice module receiving a test result of a subject in a gene test;
the supporting advice module making a decision for the test result by means of a corresponding gene comparison module which comprises an adult genome comparison module and a child genome comparison module wherein the adult genome comparison module/the child genome comparison module is applicable to significant genetic data of an adult/a child);
the corresponding gene comparison module comparing the test result with significant genetic data to produce a therapeutic formula combination; and
the supporting advice module transmitting the therapeutic formula combination to a gene test user interface.

2. A gene test platform method as claimed in claim 1 wherein the gene test user interface further comprises a feedback interface through which an external user sends any feedback or raises any question and a service agent replies to the external user.

3. A gene test platform method as claimed in claim 1 wherein the therapeutic formula combination comprises a nutrient combination as a recommendation for an adult or a child, a drug combination as a recommendation for an adult, and an educational material combination as a recommendation for a child.

4. A gene test platform method as claimed in claim 1 wherein both the significant genetic data and the therapeutic formula combination are stored in a database.

5. A gene test platform method as claimed in claim 1 wherein the gene test user interface further comprises a therapy tracing interface for an external user or an external service agent.
